(19) United States
(12) Patent Application Publication
(10) Pub. No.: US 2025/0226714 A1
(43) Pub. Date: Jul. 10, 2025

(54) STATOR WINDINGS WITH ODD CONDUCTORS LAYERS

(71) Applicant: Rivian IP Holdings, LLC, Irvine, CA (US)

(72) Inventors: Fan Wu, Rancho Palos Verdes, CA (US); Khwaja Rahman, Troy, MI (US); Logan Noel Balliett, Los Angeles, CA (US)

(73) Assignee: Rivian IP Holdings, LLC, Irvine, CA (US)

(21) Appl. No.: 18/404,101

(22) Filed: Jan. 4, 2024

(51) Int. Cl. H02K 3/28; B60K 1/04

(52) U.S. Cl. CPC H02K 3/28; B60K 1/04

(57) ABSTRACT

A motor can include a stator. The stator can include a first slot and a second slot. The first slot can be associated with a first phase. The first slot can receive an odd number of conductors associated with the first phase. The second slot can be associated with the first phase. The second slot can receive a subset of the even number of conductors associated with the first phase. The second slot can be different from the first slot.

### INTRODUCTION

Vehicles can include electrical components. The electrical components can be electrically coupled with one another.

### SUMMARY

This disclosure is generally related to one or more components of a vehicle. The components can include at least one motor. The motor can include at least one drive assembly component. For example, the motor can include a stator. The stator can include at least one slot and/or opening. The slots can receive and/or accept conductors. For example, the slots can receive conductors that are associated with one or more electrical phases. The conductors can provide electrical current, electrical voltage, and/or electrical power. The motor can be included with a vehicle or included with one or more vehicle components. For example, the motor can be included in an electric vehicle. To continue this example, the stator can electrically couple with a power source (e.g., a battery) of the electric vehicle.

At least one aspect is directed to a motor. The motor can include a stator. The stator can include a first slot. The first slot can be associated with a first phase. The first slot can receive an odd number of conductors associated with the first phase. The stator can also include a second slot. The second slot can be associated with the first phase. The second slot can receive a subset of the odd number of conductors associated with the first phase. The second slot can be different from the first slot.

At least one aspect is directed to a vehicle. The vehicle can include a motor. The motor can include a stator. The stator can include a first slot. The first slot can be associated with a first phase. The first slot can receive an odd number of conductors associated with the first phase. The stator can also include a second slot. The second slot can be associated with the first phase. The second slot can receive a subset of the odd number of conductors associated with the first phase. The second slot can be different from the first slot.

At least one aspect is directed to a method. The method can include disposing, within a first slot of a stator, an odd number of conductors associated with a first phase. The first slot of the stator can be associated with the first phase. The method can also include disposing, within a second slot of the stator, a subset of the odd number of conductors associated with the first phase. The second slot associated with the first phase, and the second slot different than the first slot.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an electric vehicle, in accordance with an implementation.

FIG. 2 is a perspective view of a motor having a stator and one or more conductors, in accordance with an implementation.

FIG. 3 is a perspective view of the motor illustrated in FIG. 2, in accordance with an implementation.

FIG. 4 is a perspective view of one or more conductors illustrated in FIG. 2, in accordance with an implementation.

FIG. 5 is a perspective view of the motor illustrated in FIG. 2, in accordance with an implementation.

FIG. 6 is a perspective view of the motor illustrated in FIG. 2, in accordance with an implementation.

FIG. 7 is a perspective view of the motor illustrated in FIG. 2, in accordance with an implementation.

FIG. 8 is a flow diagram of a process for manufacturing a stator having one or more conductors, in accordance with an implementation.

### DETAILED DESCRIPTION

Following below are more detailed descriptions of various concepts related to, and implementations of, methods, apparatuses, and systems of a drive unit assembly. The various concepts introduced above and discussed in greater detail below may be implemented in any of numerous ways.

The present disclosure is directed to systems and methods of one or more components for a vehicle. The components can include at least one drive unit assembly. For example, the components can include a stator. The stator can include one or more conductors. For example, the stator can include conductors that provide electrical power. The stator can include or provide a three-phase electric system. For example, the stator can include conductors that are associated with one or more phases.

The stator can include one or more slots. For example, the stator can include a first slot and a second slots. The slots can receive one or more conductors. For example, the first slot can receive a first number of conductors and the second slot can receive a second number of conductors. The conductors can be associated with one or more phases. For example, the first number of conductors can be associated with a first phase and the second number of conductors can be associated with a second phase.

The conductors can be positioned or located across or within the stator based on one or more patterns. For example, a first slot of the stator can receive conductors associated with a first phase. To continue this example, a second slot of the stator can be positioned proximate to a first side of the first slot and a third slot of the stator can be positioned proximate to a second side of the first slot. The second slot can be associated with the first phase, a second phase, or a third phase. The third slot can be associated with the first phase, the second phase, or the third phase. The placement of conductors, according to phase, can include at least one pattern. The conductors can also include a staggered and/or alternating pattern. For example, a first slot can receive a first number of conductors. To continue this example, a second slot can receive a first subset of the first number of conductors and a second slot can receive a second subset of the first number of conductors.

Layers or openings, within a stator slot, can impact or limit a number of conductor turns. For example, stators having an even number of layers (e.g., a single slot receives an even number of conductors) can impact a number of turns across the stator for the even number of conductors. The number of turns per phase can impact or define one or more relationships. For example, turns per phase can impact a torque-speed envelope.

Some technical solutions of the present disclosure include providing a stator that includes conductors having a winding design. The winding design can result in the conductors being transposed to similar layers within one or more slots of the stator. For example, a first conductor can be located or positioned within a first layer of a first slot. To continue this example, the first conductor can also be located or position within a second layer of a second slot. The assembly or design of the conductor creates space or room between conductors of a given slot which results in the conductors being transposed to the same layer in multiple slots.

The winding design described herein can provide improved flexibility or configuration options with respect to a number of turns for the conductors. For example, uniform transposition of the conductors, based on the winding design described herein, creates or provides additional room for subsequent conductors to be transposed across one or more slots of the stator. The improvement in configuration can enhance a torque-speed curve that is associated with a motor given that number of turns for the conductors can define the torque-speed curve. The enhancement of the torque-speed curve can improve overall performance of the motor or a vehicle that includes the motor.

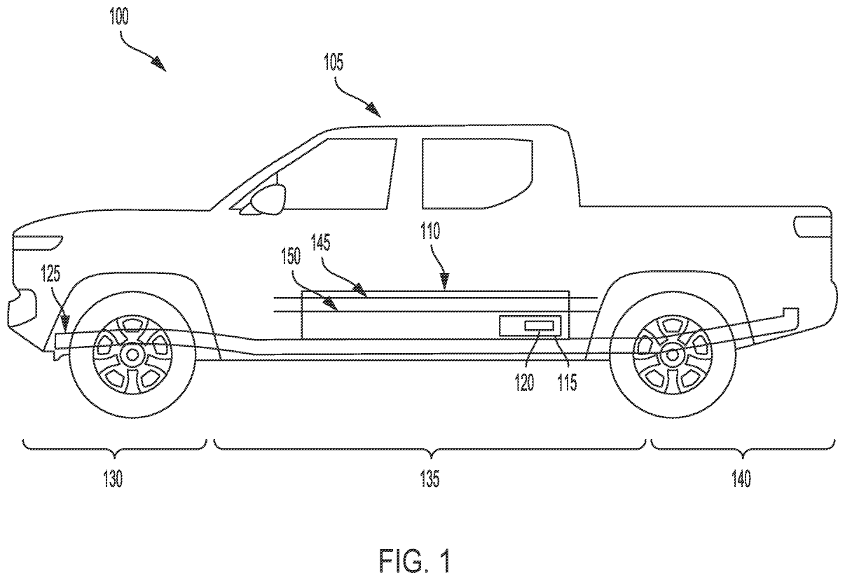

FIG. 1 depicts an example cross-sectional view 100 of an electric vehicle 105 installed with at least one battery pack 110. Electric vehicles 105 can include electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. The battery pack 110 can also be used as an energy storage system to power a building, such as a residential home or commercial building. Electric vehicles 105 can be fully electric or partially electric (e.g., plug-in hybrid) and further, electric vehicles 105 can be fully autonomous, partially autonomous, or unmanned. Electric vehicles 105 can also be human operated or non-autonomous. Electric vehicles 105 such as electric trucks or automobiles can include on-board battery packs 110, batteries 115 or battery modules 115, or battery cells 120 to power the electric vehicles. The electric vehicle 105 can include a chassis 125 (e.g., a frame, internal frame, or support structure). The chassis 125 can support various components of the electric vehicle 105. The chassis 125 can span a front portion 130 (e.g., a hood or bonnet portion), a body portion 135, and a rear portion 140 (e.g., a trunk, payload, or boot portion) of the electric vehicle 105. The battery pack 110 can be installed or placed within the electric vehicle 105. For example, the battery pack 110 can be installed on the chassis 125 of the electric vehicle 105 within one or more of the front portion 130, the body portion 135, or the rear portion 140. The battery pack 110 can include or connect with at least one busbar, e.g., a current collector element. For example, the first busbar 145 and the second busbar 150 can include electrically conductive material to connect or otherwise electrically couple the battery 115, the battery modules 115, or the battery cells 120 with other electrical components of the electric vehicle 105 to provide electrical power to various systems or components of the electric vehicle 105.

The battery pack 110 can provide power to electric vehicle 105. Battery packs 110 can include any arrangement or network of electrical, electronic, mechanical or electromechanical devices to power a vehicle of any type, such as the electric vehicle 105. The battery pack 110 can include at least one housing. The housing can include at least one battery module 115 or at least one battery cell 120, as well as other battery pack components. The battery module 115 can be or can include one or more groups of prismatic cells, cylindrical cells, pouch cells, or other form factors of battery cells 120. The housing can include a shield on the bottom or underneath the battery module 115 to protect the battery module 115 and/or cells 120 from external conditions, for example if the electric vehicle 105 is driven over rough terrains (e.g., off-road, trenches, rocks, etc.) The battery pack 110 can include at least one cooling line that can distribute fluid through the battery pack 110 as part of a thermal/temperature control or heat exchange system that can also include at least one thermal component (e.g., cold plate). The thermal component can be positioned in relation to a top submodule and a bottom submodule, such as in between the top and bottom submodules, among other possibilities. The battery pack 110 can include any number of thermal components. For example, there can be one or more thermal components per battery pack 110, or per battery module 115. At least one cooling line can be coupled with, part of, or independent from the thermal component.

The battery modules 115 can each include a plurality of battery cells 120. The battery modules 115 can be disposed within the housing of the battery pack 110. The battery modules 115 can include battery cells 120 that are cylindrical cells or prismatic cells, for example. The battery module 115 can operate as a modular unit of battery cells 120. For example, a battery module 115 can collect current or electrical power from the battery cells 120 that are included in the battery module 115 and can provide the current or electrical power as output from the battery pack 110. The battery pack 110 can include any number of battery modules 115. For example, the battery pack can have one, two, three, four, five, six, seven, eight, nine, ten, eleven, twelve or other number of battery modules 115 disposed in the housing.

The battery modules 115 can be square, rectangular, circular, triangular, symmetrical, or asymmetrical. In some examples, battery modules 115 may be different shapes, such that some battery modules 115 are rectangular but other battery modules 115 are square shaped, among other possibilities. The battery module 115 can include or define a plurality of slots, holders, or containers for a plurality of battery cells 120. It should be noted the illustrations and descriptions herein are provided for example purposes and should not be interpreted as limiting.

The battery cell 120 can be included in battery modules 115 or battery packs 110 to power components of the electric vehicle 105. The housing can be disposed in the battery module 115, the battery pack 110, or a battery array installed in the electric vehicle 105. The battery cell housing can be of any shape, such as cylindrical with a circular, elliptical, or ovular base, among others. The shape of the housing can also be prismatic with a polygonal base. The housing can include a pouch form factor. The housing can include other form factors, such as a triangle, a square, a rectangle, a pentagon, and a hexagon, among others. In some embodiments, the battery pack may not include modules (e.g., module-free). For example, the battery pack can have a module-free or cell-to-pack configuration where the battery cells are arranged directly into a battery pack without assembly into a module.

Current collector materials (e.g., a current collector foil to which an electrode active material is laminated to form a cathode layer or an anode layer) can include a metal material. For example, current collector materials can include aluminum, copper, nickel, titanium, stainless steel, or carbonaceous materials. The current collector material can be formed as a metal foil. For example, the current collector material can be an aluminum (Al) or copper (Cu) foil. The current collector material can be a metal alloy, made of Al, Cu, Ni, Fe, Ti, or combination thereof. The current collector material can be a metal foil coated with a carbon material, such as carbon-coated aluminum foil, carbon-coated copper foil, or other carbon-coated foil material.

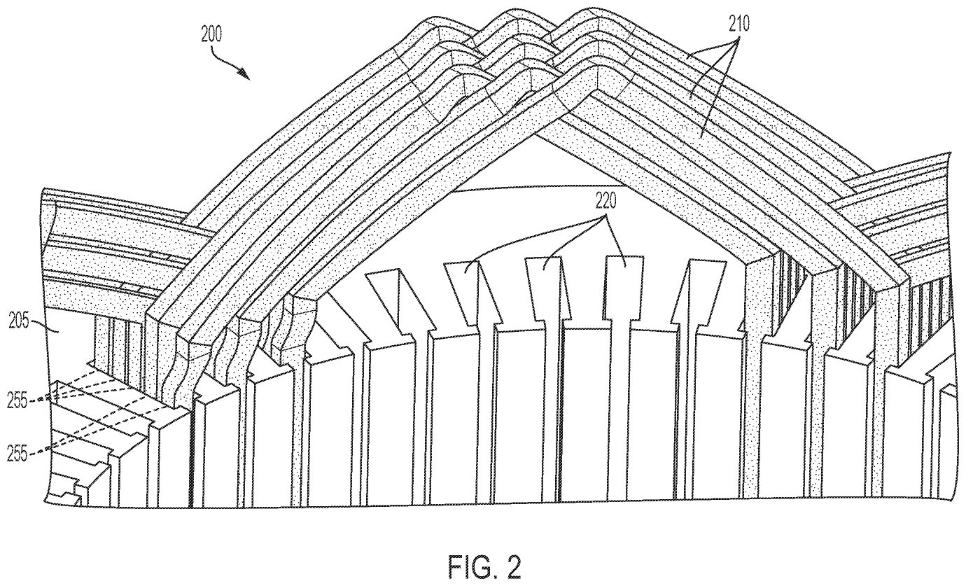

FIG. 2 depicts a perspective view of a motor 200. The motor 200 can be coupled with a vehicle. For example, the motor 200 can be coupled with the vehicle 105. The motor 200 can be included with the vehicle 105. For example, the motor 200 can be disposed within the vehicle 105. The motor 200 can be provided as one or more components for the vehicle 105. For example, the motor 200 can be disposed within the vehicle 105 subsequent to assembly of the vehicle 105. The motor 200 can include one or more electrical components. For example, the motor 200 can include components that can coupled with a power source (e.g., the batteries 115). The motor can include at least one stator 205. The stator 205 can be included in or provided as a drive unit assembly. The stator 205 can electrically couple with one or more components. For example, the stator can electrically couple with an inverter. As another example, the stator 205 can be electrically coupled with the batteries 115.

The stator 205 can include at least one slot 220. The slots 220 can include or define at least one cavity. The slots 220 can receive or accept at least one conductor 210. The conductors 210 can include the conductors described herein. The stator 205 can include one or more slots 220 associated with one or more phases. For example, the stator 205 can include a first slot 220 and a second slot 220. To continue this example, the first slot 220 can be associated with a first phase and the second slot 220 can also be associated with a first phase. The slots 220 can be associated with one or more phases based on a placement of a given slot 220 within the stator 205. The slots 220 can be associated with one or more phases responsive to a given slot 220 receiving or accepting one or more conductors 210 associated with a given phase.

The slots 220 can include varying numbers or quantities of conductors. For example, a first slot 220 can receive a first number of conductors 210. To continue this example, the first number of conductors 210 can be associated with a first phase. The numbers or quantities of conductors can include different amounts. For example, the slots 220 can include one or more layers 255 and the layers 255 can define openings or space to receive one or more conductors 210. The slots 220 can receive one or more subsets of conductors 210. For example, a first slot 220 can include a first subset of conductors 210 and a second subset of conductors 210. To continue this example, the first subset of conductors 210 can also be included in a second slot 220 and the second subset of conductors 210 can also be included in a third slot 220.

The slots 220 can receive a total odd number of conductors 210. For example, a first slot 220 can receive an odd number of conductors 210 associated with a given phase. As another example, a second slot 220 can receive a subset of the odd number of conductors 210 associated with the given phase. To continue this example, the second slot 220 can also receive a subset of conductors 210 that are included in a third slot 220. As a non-limiting example, a first slot 220 can accommodate or provide room for five conductors 210 (e.g., the first slot 220 includes five layers 255). To continue this non-limiting example, the first slot 220 can receive the five conductors 210 (e.g., an odd number of conductors). In this non-limiting example, the first slot 220 can be associated with a single given phase responsive to the five conductors 210 being associated with the single given phase.

The layers 255 can include various placements, arrangements, or positioning. For example, as shown in FIG. 2, a slot 220 is shown to have five layers 255 with each layer 255 corresponding to a given conductor 210. The layer 255 that is closet to a center point (e.g., a center of a void or opening) of the stator 205 can be considered a first layer or a front layer. The numberings of the layer 255 can follow one or more patterns.

FIG. 2 provides an example of the conductors 210 being associated with a single given phase. For example, the conductors 210 can be associated with the first phase. As shown in FIG. 2, the conductors 210 associated with the first phase can be grouped or bunched in groups of three slots 220. For example, three adjacent slots 220 can receive conductors associated with the first phase. As shown in FIG. 2, each bunched slot 220 can receive an odd number of conductors 210. The bunched slots 220 can received subsets of conductors 210 from one or more subsequent slots 220.

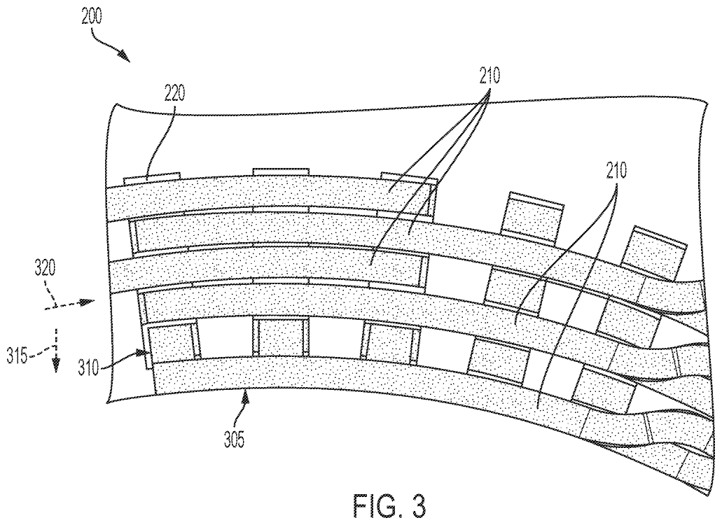

FIG. 3 is a perspective top view of the motor 200. The perspective top view, as shown in FIG. 3, includes an enlarged view of the conductors 210. The conductors 210 can travel, extend, or otherwise transpose in or across one or more directions. For example, the conductors 210 can exit or escape a body of the stator 205 and the conductors 210 can then travel in a given direction. As described herein, the slots 220 can include one or more layers 255 and the layers 255 can define or represent a placement of the conductors. For example, a first layer 255 may represent a first position. As another example, a second layer 255 may represent a second position. A first slot 220 can include a first conductor 210 and a second conductor 210. The first conductor 210 can be located in a first or front layer 255 and the second conductor can be located in a second or subsequent layer 255. The first conductor 210 can include one or more portions. For example, the first conductor can include portions 305 and portion 310. The portion 305 can travel in one or more directions external to the slot 220. For example, the portion 305 can travel in a direction 320. The portion 310 can travel in or more directions external to the slot 220. For example, the portion 310 can travel in a direction 315. As shown in FIG. 3, the portion 310 traveling in the direction 315 creates space between the conductor 210, in the first layer 255, and the conductor 210 in the second layer 255. The conductor 210, in the second layer, can also travel in one or more directions. For example, the conductor, in the second layer, can travel in the direction 320.

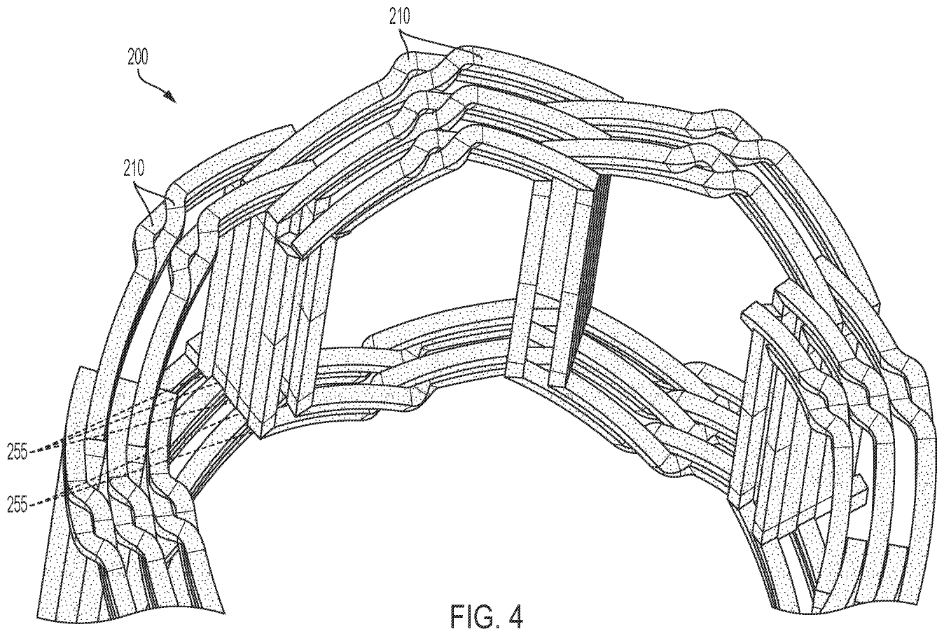

FIG. 4 is a perspective view of conductors 210. The conductors 210 can include or experience one or more turns. For example, the conductors 210 can have one or more bends or curves. To continue this example, the bends or curves can refer to or include turns. As shown in FIG. 4, the conductors 210 can overlap with one or another. For example, a first conductor 210 can be on top of or superior to a second conductor 210. As another example, a first conductor 210 and a second conductor 210 can be intertwined or interlocked with one another. FIG. 4 depicts an example of space or room that is created between a front layer conductor 210 and a subsequent conductor 210 responsive to the front layer conductor 210 having moved in the direction 315.

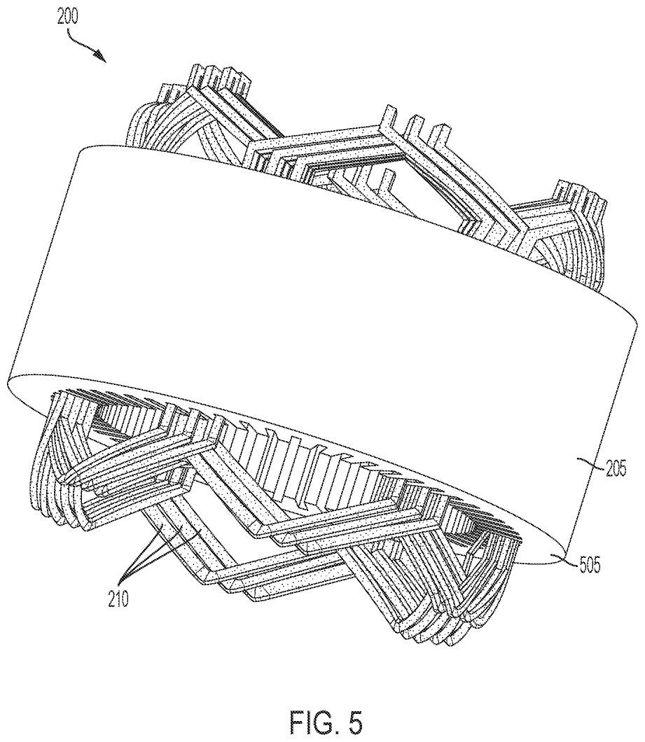

FIG. 5 is a perspective view of the motor 200. The stator 205 can include at least one face 505. For example, the stator 205 can include a first face 505 and a second face 505. The faces 505 can refer to or include at least one of a top face, a bottom face, a top side, or a bottom side. The conductors 210 can be located external to the faces 505. For example, a first portion of the conductors 210 can be located external to a first face 505. As another example, a second portion of the conductors 210 can be located external to a second face 505.

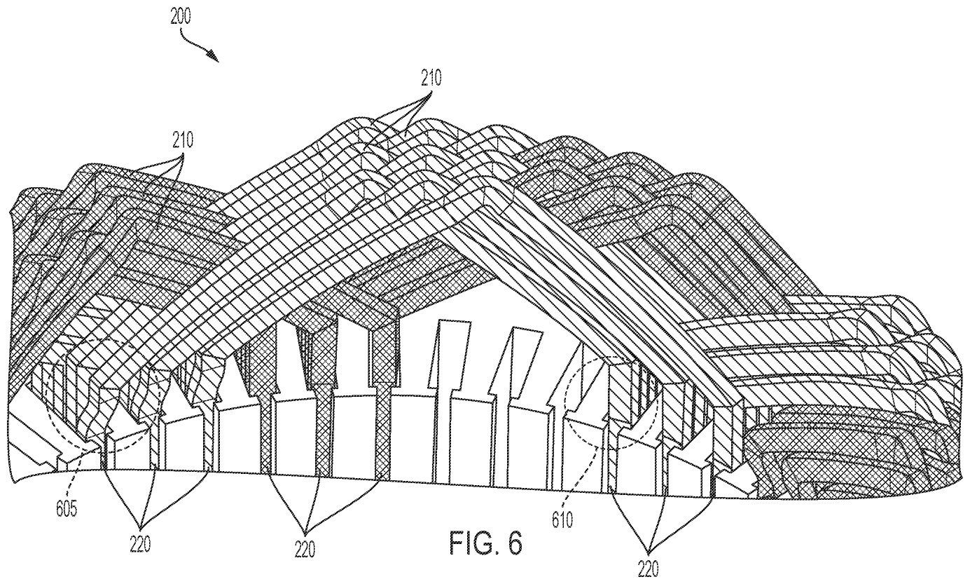

FIG. 6 is a perspective view of the motor 200. FIG. 6 depicts an example of the stator 205 including one or more first conductors 210 associated with a first phase and one or more second conductors 210 associated with a second phase. FIG. 6 is shown to include highlighted portion 605 and highlighted portion 610. The highlighted portion 605 illustrates an example of a slot 220 that includes a number of conductors 210 associated with a first phase. The highlighted portion 605 also illustrates that a first or front conductor 210 (e.g., a front layer 255 of a first slot 220) has moved in the direction 315 to create space between the first conductor 210 and a subsequent conductor 210. The highlighted portion 610 illustrates an example of the first conductor 210, of the highlighted portion 605, having transposed or traveled, to a first layer 255 of a second slot 220. The highlighted portion 610 also illustrates that the first conductor 210 is flush or orientated in unison with the subsequent conductor 210.

As shown in FIG. 6, the conductors 210 associated with a first given phase are located in three adjacent slots 220 and the conductors 210 associated with a second given phase are also located in three adjacent slots 220. The slots 220 including the conductors 210 associated with the first given phase can also be associated with the first given phase. The slots 220 including the conductors 210 associated with the second given phase can also be associated with the second given phase.

FIG. 6 depicts an example of the slots 220 being bundled or bunched such that one or more slots 220 associated with a given phase are adjacent to subsequent slots 220 that are also associated with the given phase. As shown in FIG. 6, the slots 220 are bundled in groups of three such that a first given slot 220 is disposed between a second given slot 220 and a third given slot 220. The groups of three (e.g., the bundled slots 220) can be associated with a given phase. FIG. 6 depicts an example of a first set of bundled slots 220 being associated with a first phase and an example of a second set of bundled slots 220 being associated with a second phase. The sets of bundled slots 220 can be adjacent to one another. For example, a set of bundled slots 220 associated with a first phase can be adjacent to a second of bundled slots 220 associated with a second phase.

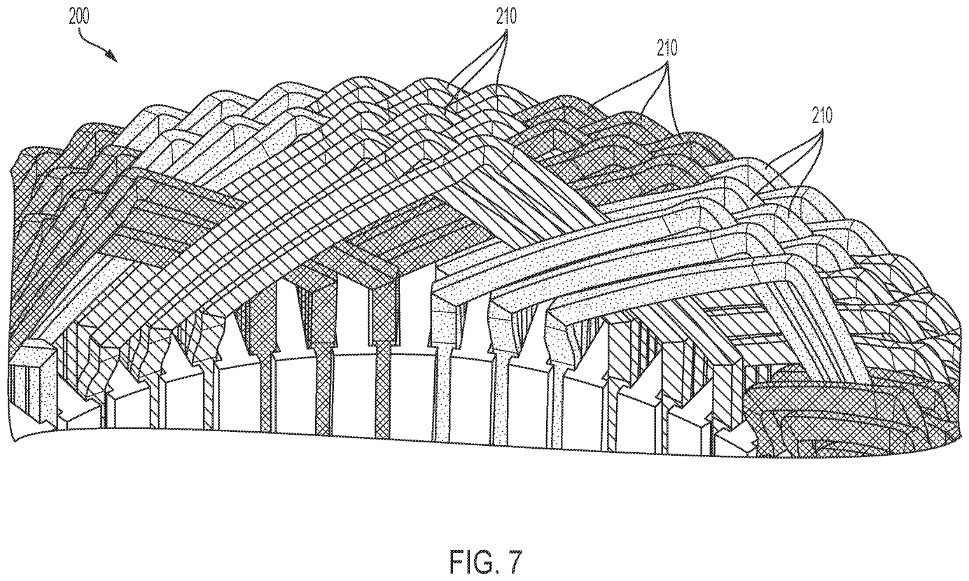

FIG. 7 is a perspective view of the motor 200. FIG. 7 depicts an example of the stator 205 including one or more first conductors 210 associated with a first phase, one or more second conductors 210 associated with a second phase, and one or more third conductors 210 associated with a third phase. The stator 205 can include at least one pattern or arrangement. For example, the stator 205 can include a staggered arrangement of conductors 210. Stated otherwise, the position and/or placement of the conductors 210 can be staggered across the stator 205. The staggered pattern can include the bundled slots described herein. For example, three adjacent slots 220 can each receive conductors 210 associated with a given phase. To continue this example, each slot 220 of the three adjacent slots 220 can receive an odd number of conductors 210. The odd number of conductors 210 can be or include one or more subsets. For example, a first slot 220 can receive a first subset of conductors 210 from a second slot 220 and the first slot 220 can receive a second subset of conductors 210 from a third slot 220. This bundled slot design can be repeated or reused for one or more slots 220 associated with various phases.

The pattern of the conductors 210 can include one or more predetermined or prearranged patterns. For example, a first conductor 210 can have a first portion 405 that is positioned in a first layer 255 of a first slot 220 and the first conductor 210 can have a second portion 405 that is positioned in a first layer 255 of a second slot 220. As another example, a second conductor 210 can have a first portion 405 that is positioned in a second layer 255 of the first slot 220 and the second conductor 210 can have a second portion 405 that is positioned in a third layer 255 of the second slot 220.

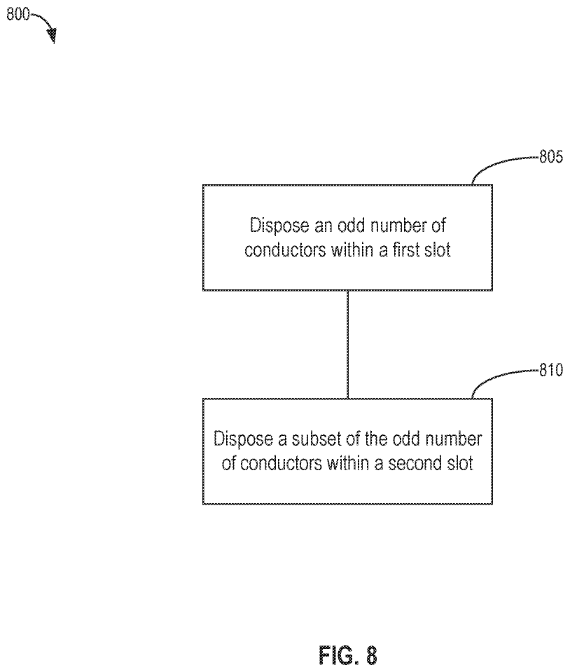

FIG. 8 is a flow diagram of a process 800 for manufacturing a stator. The stator can include the stator 205. The manufacturing of the stator 205 can include providing the stator 205. For example, the stator 205 can be provided during assembly of the vehicle 105. The stator 205 can be provided responsive to the stator 205 having been purchased.

At act 805, an odd number of conductors can be disposed. For example, an odd number of conductors 210 can be disposed. The odd number of conductors 210 can be disposed within a slot 220. The odd number of conductors 210 can be disposed within the slot 220 by at least one of placing, positioning, locating, or otherwise situating the even number of conductors 210 within the slot 220. The slot 220 can be associated with a given phase. For example, the slot 220 can be associated with the first phase. The odd number of conductors 210 can be associated with the first phase. The odd number of conductors 210 can include five conductors.

At act 810, a subset of the odd number of conductors can be disposed. For example, a subset of the odd number of conductors 210 disposed within the slot 220, in act 805, can also be disposed within a second slot 220. As another example, a first portion of the odd number of conductors 210 can be disposed within the slot 220 and a second portion of the subset of the odd number of conductors 210 can be disposed within a second slot 220. The subset of the odd number of conductors 210 can be disposed within the second slot 220 by at least one of placing, positioning, locating, or otherwise situating the subset of the even number of conductors 210 and the first number of conductors within the slot 220. The subset of the odd number of conductors 210 can include at least one of two conductors or three conductors. The second slot 220 can be associated with the first phase. The second slot 220 can be different from the first slot 220. For example, the first slot 220 and the second slot 220 can be different slots.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C #, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, descriptions of positive and negative electrical characteristics may be reversed. Elements described as negative elements can instead be configured as positive elements and elements described as positive elements can instead by configured as negative elements. For example, elements described as having first polarity can instead have a second polarity, and elements described as having a second polarity can instead have a first polarity. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. A motor, comprising:
a stator, including:
a first slot associated with a first phase, the first slot configured to receive an odd number of conductors associated with the first phase; and
a second slot associated with the first phase, the second slot configured to receive a subset of the odd number of conductors associated with the first phase, and the second slot different from the first slot.

2. The motor of claim 1, comprising:
the stator, including:
a third slot disposed adjacent to the first slot, the third slot associated with the first phase, and the third slot configured to receive a second odd number of conductors associated with the first phase;
the odd number of conductors associated with the first phase different than the second odd number of conductors;
the odd number of conductors associated with the first phase having a first number of conductors;
the second odd number of conductors associated with the first phase having a second number of conductors; and
the first number of conductors and the second number of conductors are the same.

3. The motor of claim 1, comprising:
the stator, including:
a first conductor of the odd number of conductors associated with the first phase, the first conductor including:
a first portion configured to dispose within a first position of the first slot; and
a second portion configured to dispose within a second position of the second slot;
wherein a placement of the first portion within the first position of the first slot is the same as a placement of the second portion within the second position of the second slot.

4. The motor of claim 1, comprising:
the stator, including:
a first conductor of the odd number of conductors and a second conductor of the odd number of conductors;
the first conductor having:
a first portion configured to travel in a first direction external to the first slot; and
a second portion coupled with the first portion, the second portion configured to travel in a second direction external to the first slot; and
the second conductor having a portion configured to travel in the second direction external to the first slot;
wherein the first direction external to the first slot and the second direction external to the first slot are different.

5. The motor of claim 1, comprising:
the stator, including:
a third slot associated with the first phase and the third slot configured to receive a second subset of the odd number of conductors associated with the first phase;
a first number of slots of the stator disposed between the first slot and the second slot; and
a second number of slots of the stator disposed between the first slot and the third slot;
wherein the first number of slots and the second number of slots are the same.

6. The motor of claim 1, comprising:
the stator, including:
a third slot disposed adjacent to the first slot, the third slot associated with the first phase, and the third slot configured to receive a second odd number of conductors associated with the first phase; and
a fourth slot disposed adjacent to the second slot, the fourth slot associated with the first phase, and the fourth slot configured to receive a subset of the second odd number of conductors associated with the first phase;
the subset of the odd number of conductors associated with the first phase having a first number of conductors;
the subset of the second odd number of conductors associated with the first phase having a second number of conductors; and
the first number of conductors and the second number of conductors are the same.

7. The motor of claim 1, comprising:
the stator, including:
a third slot disposed adjacent to the first slot, the third slot associated with the first phase, and the third slot configured to receive a second odd number of conductors associated with the first phase;
the subset of the odd number of conductors associated with the first phase configured to travel, from the first slot to the second slot, in a first direction;
a subset of the second odd number of conductors associated with the first phase configured to travel, from the third slot to a fourth slot, in the first direction; and
the subset of the odd number of conductors located superior to the subset of the second odd number of conductors when the subset of the odd number of conductors and the subset of the second odd number of conductors both travel in the first direction.

8. The motor of claim 1, comprising:
the stator, including:
a third slot disposed adjacent to the first slot, the third slot associated with a second phase, and the third slot configured to receive a second odd number of conductors associated with the second phase; and
a fourth slot disposed adjacent to the second slot, the fourth slot associated with the second phase, and the fourth slot configured to receive a subset of the second odd number of conductors associated with the second phase;
the subset of the odd number of conductors associated with the first phase having a first number of conductors;
the subset of the second odd number of conductors associated with the second phase having a second number of conductors;
the first number of conductors and the second number of conductors are the same.

9. The motor of claim 1, wherein the motor includes three phases, wherein the three phases, include the first phase, a second phase, and a third phase, and further comprising:
the stator, including:
a plurality of slots, including:
one or more first slots associated with the first phase, the one or more first slots including the first slot and the second slot;
one or more second slots associated with the second phase; and
one or more third slots associated with the third phase;
a plurality of conductors including the odd number of conductors, the plurality of conductors configured to dispose within at least one of the one or more first slots, the one or more second slots, or the one or more third slots based on a predetermined pattern; and
the predetermined pattern to define:
a staggered placement of the one or more first slots relative to the one or more second slots and relative to the one or more third slots;
wherein a first group of slots of the one or more first slots are disposed between a first group of slots of the one or more second slots and a first group of slots of the one or more third slots based on the staggered placement.

10. A vehicle, comprising:
a motor, including:
a stator, including:
a first slot associated with a first phase, the first slot configured to receive an odd number of conductors associated with the first phase; and
a second slot associated with the first phase, the second slot configured to receive a subset of the odd number of conductors associated with the first phase, and the second slot different from the first slot.

11. The vehicle of claim 10, comprising:
the stator, including:
a third slot disposed adjacent to the first slot, the third slot associated with the first phase, and the third slot configured to receive a second odd number of conductors associated with the first phase;
the odd number of conductors associated with the first phase different than the second odd number of conductors;
the odd number of conductors associated with the first phase having a first number of conductors;
the second odd number of conductors associated with the first phase having a second number of conductors; and
the first number of conductors and the second number of conductors are the same.

12. The vehicle of claim 10, comprising:
the stator, including:
a first conductor of the odd number of conductors associated with the first phase, the first conductor including:
a first portion configured to dispose within a first position of the first slot; and
a second portion configured to dispose within a second position of the second slot;
wherein a placement of the first portion within the first position of the first slot is the same as a placement of the second portion within the second position of the second slot.

13. The vehicle of claim 10, comprising:
the stator, including:
a first conductor of the odd number of conductors and a second conductor of the odd number of conductors;
the first conductor having:
a first portion configured to travel in a first direction external to the first slot; and
a second portion coupled with the first portion, the second portion configured to travel in a second direction external to the first slot; and
the second conductor having a portion configured to travel in the second direction external to the first slot;
wherein the first direction external to the first slot and the second direction external to the first slot are different.

14. The vehicle of claim 10, comprising:
the stator, including:
a third slot associated with the first phase and the third slot configured to receive a second subset of the odd number of conductors associated with the first phase;
a first number of slots of the stator disposed between the first slot and the second slot; and
a second number of slots of the stator disposed between the first slot and the third slot;
wherein the first number of slots and the second number of slots are the same.

15. The vehicle of claim 10, comprising:
the stator, including:
a third slot disposed adjacent to the first slot, the third slot associated with the first phase, and the third slot configured to receive a second odd number of conductors associated with the first phase; and
a fourth slot disposed adjacent to the second slot, the fourth slot associated with the first phase, and the fourth slot configured to receive a subset of the second odd number of conductors associated with the first phase;
the subset of the odd number of conductors associated with the first phase having a first number of conductors;
the subset of the second odd number of conductors associated with the first phase having a second number of conductors; and
the first number of conductors and the second number of conductors are the same.

16. The vehicle of claim 10, comprising:
the stator, including:
a third slot disposed adjacent to the first slot, the third slot associated with the first phase, and the third slot configured to receive a second odd number of conductors associated with the first phase;
the subset of the odd number of conductors associated with the first phase configured to travel, from the first slot to the second slot, in a first direction;
a subset of the second odd number of conductors associated with the first phase configured to travel, from the third slot to a fourth slot, in the first direction; and
the subset of the odd number of conductors located superior to the subset of the second odd number of conductors when the subset of the odd number of conductors and the subset of the second odd number of conductors both travel in the first direction.

17. The vehicle of claim 10, comprising:
the stator, including:
a third slot disposed adjacent to the first slot, the third slot associated with a second phase, and the third slot configured to receive a second odd number of conductors associated with the second phase; and
a fourth slot disposed adjacent to the second slot, the fourth slot associated with the second phase, and the fourth slot configured to receive a subset of the second odd number of conductors associated with the second phase;
the subset of the odd number of conductors associated with the first phase having a first number of conductors;
the subset of the second odd number of conductors associated with the second phase having a second number of conductors;
the first number of conductors and the second number of conductors are the same.

18. The vehicle of claim 10, wherein the motor includes three phases, wherein the three phases, include the first phase, a second phase, and a third phase, and further comprising:
the stator, including:
a plurality of slots, including:
one or more first slots associated with the first phase, the one or more first slots including the first slot and the second slot;
one or more second slots associated with the second phase; and
one or more third slots associated with the third phase;
a plurality of conductors including the odd number of conductors, the plurality of conductors configured to dispose within at least one of the one or more first slots, the one or more second slots, or the one or more third slots based on a predetermined pattern; and
the predetermined pattern to define:
a staggered placement of the one or more first slots relative to the one or more second slots and relative to the one or more third slots;
wherein a first group of slots of the one or more first slots are disposed between a first group of slots of the one or more second slots and a first group of slots of the one or more third slots based on the staggered placement.

19. A method, comprising:
disposing, within a first slot of a stator, an odd number of conductors associated with a first phase, the first slot of the stator associated with the first phase; and
disposing, within a second slot of the stator, a subset of the odd number of conductors associated with the first phase, the second slot associated with the first phase, and the second slot different than the first slot.

20. The method of claim 19, comprising:
disposing, within a third slot of the stator, a second odd number of conductors associated with the first phase, the third slot of the stator adjacent to the first slot, and the third slot associated with the first phase.
